(19) United States
(12) Patent Application Publication
(10) Pub. No.: US 2024/0010061 A1
(43) Pub. Date: Jan. 11, 2024

(54) SEALING PROFILE, SEALING ARRANGEMENT AND FASTENING METHOD

(71) Applicant: CQLT SAARGUMMI TECHNOLOGIES S.À.R.L., Remich (LU)

(72) Inventor: Daniel THIEL, Beckingen-Oppen (DE)

(21) Appl. No.: 18/021,607

(22) PCT Filed: Oct. 1, 2021
(86) PCT No.: PCT/EP2021/000115

§ 371 Date: Feb. 16, 2023

(30) Foreign Application Priority Data
Oct. 6, 2020 (DE) 10 2020 126 093.8

(51) Int. Cl. B60J 10/76; B60J 10/36; B60J 10/15

(52) U.S. Cl. CPC B60J 10/76; B60J 10/36; B60J 10/15

(57) ABSTRACT

A sealing profile for a motor vehicle, in particular for a window channel of a motor vehicle, including a sealing portion and a fastening portion, a sealing arrangement having such a sealing profile, and a fastening method. The fastening portion has at least two protruding fastening members, between which a receiving portion for an expansion element is arranged.

The invention relates to a sealing profile for a motor vehicle, in particular for a window channel of a motor vehicle, to a sealing arrangement and to a fastening method for such a sealing profile.

Sealing profiles for motor vehicles which comprise a sealing portion and a fastening portion are known in practice. The sealing portion rests against one or more parts of the motor vehicle and seals them off from one another. The fastening portion can have fastening means, such as through holes, through which screws for fixing the sealing profile on the motor vehicle can be passed. Although a firm connection is produced when the screws are tightened, the position of the sealing profile on the motor vehicle is not exactly defined since the through hole in the sealing profile is always designed to be somewhat larger on account of tolerances.

It is therefore the object of the invention to provide a sealing profile, a sealing arrangement and a fastening method which make it possible to fasten the sealing profile on a motor vehicle in a simple and positionally accurate manner.

This object is achieved by virtue of the fact that the fastening portion has at least two projecting fastening members, between which a receptacle for an expansion element is arranged. If a corresponding expansion element is inserted into the receptacle, the fastening members are deformed outward and can be braced, for example, with respect to a through hole in a motor vehicle. This permits play-free fixing of the sealing profile on the motor vehicle, in particular transversely to the longitudinal direction of the motor vehicle. In addition, the fastening members also make it possible to pre-center the overall sealing profile on the motor vehicle in the longitudinal direction of the motor vehicle.

In an advantageous embodiment, the fastening members have a reducing cross section in one region in a direction away from a free end. The region with the reducing cross section is advantageously formed at the transition of the fastening members to a bearing surface of the fastening portion. It is possible, for example, for the edge of the through hole in the motor vehicle to project in a positive-locking manner into the region with the reducing cross section, thus ensuring that the sealing profile is held in a positive-locking manner even before the insertion of an expansion element, simplifying assembly.

In a further advantageous embodiment, the receptacle for the expansion element can have a cross section which widens toward the open end. This ensures that the fastening members are spread further apart, the further the expansion element projects into the receptacle. In this case, the receptacle is advantageously designed as a blind hole in the fastening portion or the sealing profile.

The fastening members and/or the bearing surface of the fastening portion designed to bear against the motor vehicle can be molded onto the sealing portion to make possible a particularly stable connection. Additionally or alternatively, the sealing portion can be designed as an extruded sealing profile, made of EPDM or TPE for example, and the fastening portion can preferably be arranged in a free space, formed by stamping, of the sealing portion.

In a further advantageous embodiment, the sealing portion can have a retention member for insertion into a window channel and/or a sealing lip for bearing against a window pane. In a particularly advantageous embodiment, the retention member can project in the same direction as the fastening members. A sealing profile of this type, which is designed as a window channel seal, can be installed in a particularly simple and positionally accurate manner and, in addition, particularly good sealing properties and improved theft protection are achieved.

The fastening portion can be inserted and overmolded in a soft molding, in particular made of TPE or EPDM, as part of a molded edge, in particular made of polypropylene, which is molded onto the sealing portion, or as an insert, preferably made of hard plastic.

Furthermore, a sealing arrangement comprising the sealing profile described above and a motor vehicle part, in particular a vehicle door, are claimed. The sealing arrangement is characterized in that a through hole is provided in the motor vehicle part, through which the fastening members of the sealing profile project, and in that an expansion element is arranged between the fastening members, which pushes the fastening members apart in order to fix the sealing profile on the motor vehicle part. The motor vehicle part can be, for example, an element of the vehicle body or a vehicle door/hatch. The expansion element can be designed as a screw, for example.

In an advantageous embodiment, the motor vehicle part is designed as a vehicle door having a slot in the form of a window channel, into which the sealing portion of the sealing profile projects at least partially. By means of the sealing portion, reliable sealing of a window pane with respect to the vehicle door is achieved, and the fastening portion permits positionally accurate fixing of the sealing profile on the vehicle door.

In a particularly advantageous embodiment, the through hole is arranged in the longitudinal direction of the window channel in the motor vehicle part. This results in particularly good support of the sealing profile in the longitudinal direction of the window channel.

In order to fix the sealing profile in a particularly secure manner on the motor vehicle part, the expansion element can have a decreasing cross section in the longitudinal direction toward a free end, as is the case, for example, with a conical screw.

It is advantageous to provide a covering cap that is connected to the expansion element and/or the fastening portion in a positive and/or nonpositive manner. The covering cap can be in the form of a hat and can be fitted onto the expansion element and/or the fastening portion in order to cover them.

In order to fix the covering cap, latching elements, e.g. laterally projecting ribs, can be provided on the fastening portion, in particular on one or more fastening members. Correspondingly, corresponding latching elements can be arranged on the covering cap on an inner side facing the latching elements in order to hold the covering cap on the fastening portion. Alternatively or in addition, projections can be provided on the covering cap, which are designed, for example, for retaining engagement in the region of the fastening members with a reducing cross section.

In addition, a method for fastening a sealing profile, in particular the sealing profile described above, on a motor vehicle part, in particular a vehicle door, is claimed. According to the method, two fastening members of a fastening portion of the sealing profile are inserted into a through hole in the motor vehicle part in a first direction, and then an expansion element is inserted into the receptacle between the fastening members in a direction opposite to the first direction in order to fix the sealing profile on the motor vehicle part. The term “opposite direction” encompasses exactly opposite orientations and/or opposite orientations with an intermediate angle of less than 20°, in particular less than 10°. In addition to positionally accurate and stable fastening, the expansion element, which is not visible and also not accessible from the outside of the motor vehicle, additionally makes possible an attractive visual appearance and enhanced theft protection.

In an advantageous embodiment, a retention member of a sealing portion of the sealing profile can be inserted into a window channel of the motor vehicle part designed as a vehicle door at the same time as the fastening members are inserted into the through hole, permitting particularly simple assembly.

Further special features and advantages of the invention will become apparent from the following description of a preferred exemplary embodiment with reference to the drawings. In the drawings:

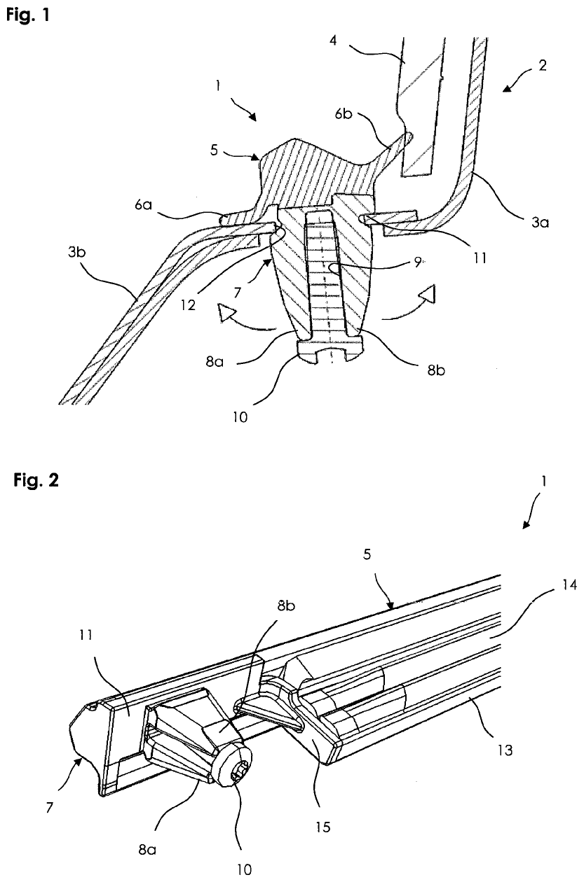

FIG. 1 shows a cross section through a sealing arrangement comprising a sealing profile and a vehicle door;

FIG. 2 shows a first perspective view of a fastening portion of the sealing profile;

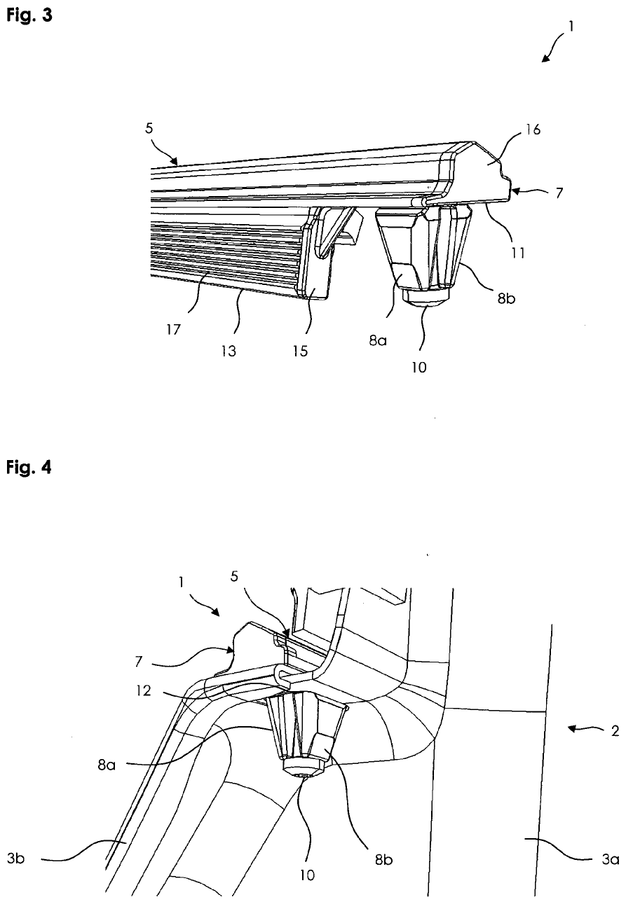

FIG. 3 shows a second perspective view of the fastening portion of FIG. 3;

FIG. 4 shows a first perspective view of the sealing arrangement of FIG. 1; and

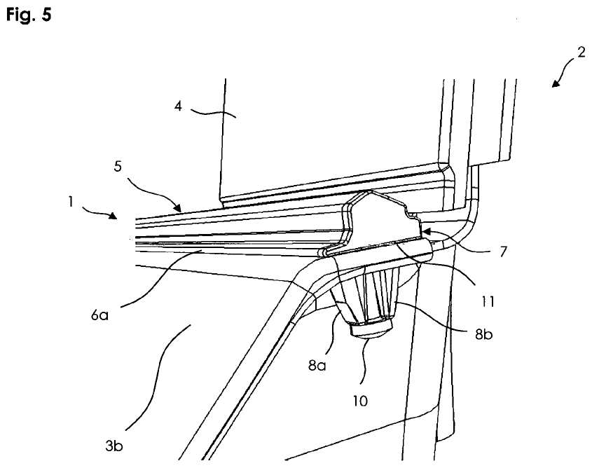

FIG. 5 shows a second perspective view of the sealing arrangement of FIG. 1.

FIG. 1 shows a cross section through a sealing arrangement comprising a sealing profile 1 and a vehicle door 2. The vehicle door 2 comprises a plurality of bent panels 3a, 3b as well as a window pane 4 movable relative to the vehicle door. The sealing profile 1 has a sealing portion 5 with sealing lips 6a, 6b for sealing the vehicle door 2 with respect to the window pane 4 and has a fastening portion 7 for fastening the sealing profile 1 on the vehicle door 2. The fastening portion 7 comprises two projecting fastening members 8a, 8b, between which a receptacle 9 for an expansion element 10 in the form of a screw is arranged. By means of the expansion element 10, the fastening members 8a, 8b are moved outward away from one another in the direction of the arrows illustrated, and the fastening portion 7 and thus the sealing profile 1 are thereby fixed reliably on the vehicle door 2.

In order to enable particularly stable and positionally accurate fixing of the fastening portion 7 on the vehicle door 2, the fastening members 8a, 8b have a reducing cross section in a direction away from a free end at a transition to a bearing surface 11. The fastening members 8a, 8b project through a through hole 12 in the vehicle door 2 as far as the region where the bearing surface 11 rests against the outer panel 3b of the vehicle door 2. The panel 3b projects in a positive-locking manner into the reducing cross section at the transition of the fastening members 8a, 8b to the bearing surface 11, thereby ensuring retention of the sealing profile 1 even before the installation of the expansion element 10. The fastening members 8a, 8b are then pushed outward by the expansion element 10 and brought into contact with the vehicle door in order to fix the sealing profile 1 in an accurate position on the vehicle door 2.

Particularly uniform spreading of the fastening members 8a, 8b is achieved by virtue of the fact that the expansion element 10 is designed as a conical screw with a cross section which decreases in the longitudinal direction toward a free end, and the receptacle 9 for the expansion element 10 has, correspondingly to this, a cross section which widens toward the open end. In addition, this makes it possible to install the expansion element 10 designed as a screw particularly quickly, which cannot be screwed in over the entire length but can instead be simply inserted into the receptacle 9 over a large part of the length.

FIG. 2 shows a first perspective view of the fastening portion 7 with the adjacent sealing portion 5 of the sealing profile 1. As can be seen there, the sealing portion 5 is designed as an extruded sealing profile with a constant cross section, and the fastening portion 7 is arranged in a free space of the sealing portion 5, which is preferably formed by stamping. The fastening portion 7 is molded onto the sealing portion 5, the fastening portion 7 consisting, as a molding, for example of a hard plastic which is molded onto the extruded component. Alternatively, the fastening portion 7 or only the fastening members 8a, 8b can also be designed as inserts made of hard plastic, which are inserted into a soft molding and overmolded. A particularly stable materially bonded connection between the sealing portion 5 and the fastening portion 7 is thereby made possible.

The sealing portion 5 has a retention member 13, which is designed for insertion into a window channel. On the retention member 13, laterally projecting additional sealing lips are arranged for resting against the window pane 4, of which sealing lip 14 is numbered by way of example. In addition to the fastening members 8a, 8b and the bearing surface 11, the fastening portion 7 additionally comprises a retention bracket 15, which preferably projects at right angles from the bearing surface 11 and is molded onto the retention member 13 of the sealing portion 5. At the transition from the retention member 13 to the retention bracket 15, the sealing lips 14 can be pressed against the retention member 13 and, in this position, can be connected materially to the retention bracket 15 in order to allow a continuous transition.

As can furthermore be seen from FIG. 2, the retention members 8a, 8b have flattened portions toward the free ends, and therefore the cross section decreases toward the free end. This makes it particularly easy to insert the fastening members 8a, 8b into the through hole 12.

The retention member 13 projects from the sealing profile 1 in the same direction as the fastening members 8a, 8b, this including slight angular deviations with an intermediate angle of less than 20°, in particular less than 10°. The retention member 13 can thus have a correspondingly small angle with respect to the fastening members 8a, 8b, allowing easy installation and, in particular, simultaneous insertion of the fastening members 8a, 8b into the through hole 12 and of the retention member 13 into a window channel (not shown) of the vehicle door 2.

FIG. 3 shows a second perspective view of the fastening portion 7 and of the sealing portion 5 of the sealing profile 1. As can be seen there, the fastening portion 7 comprises an end face 16 which adjoins the bearing surface 11 and which terminates the sealing portion 5 in the longitudinal direction and, at least in part, has an identical cross section to the sealing portion 5. The described free space in the extruded sealing profile of the sealing portion 5, in which the fastening portion 7 is arranged, can consequently be formed by a stamping process also known as notching.

It can furthermore be seen from FIG. 3 that retention ribs 17 are provided on the side of the retention member 13 opposite the additional sealing lips 14 designed to rest against the window pane 4, and when the sealing portion 5 projects at least partially into the window channel, these retention ribs rest against the vehicle door 2 with a retaining effect.

FIG. 4 shows a first perspective view of the sealing arrangement of FIG. 1. As can be seen there, the retention members 8a, 8b project inward through the through hole 12 in the vehicle door 2 and are spread apart by the expansion element 10 and thus braced against the vehicle door 2. When fastening the sealing profile 1, the two fastening members 8a, 8b are first of all inserted into the through hole 12 in a first direction until the bearing surface 11 (not shown here) comes to rest on the vehicle door 2, and then the expansion element 10 is inserted into the receptacle 9 between the fastening members 8a, 8b in a direction opposite to the first direction in order to fix the sealing profile 1 on the vehicle door 2. The fastening members 8a, 8b and the bearing surface 11 rest without play against the vehicle door 2, ensuring that the sealing profile 1 is exactly positioned and securely held in all spatial directions with respect to the vehicle door 2. The position of the expansion element 10 on the inside of the vehicle door 2 also makes improved theft protection possible since the sealing profile 1 cannot readily be removed when the vehicle door 2 is closed.

As can furthermore be seen from FIG. 4, the free ends of the fastening members 8a, 8b are of flattened, in particular level, design, thereby forming a defined stop for the expansion element 10. Advantageously, the flattened, and preferably level, free ends of the fastening members 8a, 8b can be formed in a plane at right angles to the axis of the receptacle 9. This permits particularly simple assembly since the construction can be designed in such a way that, when the screw head of the expansion element 10 designed as a screw rests against the flat ends of the fastening members 8a, 8b, the necessary deformation of the fastening members 8a, 8b for fixing the sealing profile 1 is achieved.

FIG. 5 shows a second perspective view of the sealing arrangement of FIG. 1. As can be seen there, the sealing profile 1 rests over its entire surface, inter alia by means of the bearing surface 11, against the outer panel 3b of the vehicle door 2, the transition additionally being sealed in the longitudinal direction of the sealing profile 1 by means of the sealing lip 6a. As can also be seen from a combined examination of the figures, the through hole 12 is arranged in the vehicle door 2 in the longitudinal direction of the window channel, thus ensuring that the fastening members 8a, 8b are correspondingly arranged in the longitudinal direction with respect to the retention member 13. Viewed in the longitudinal direction of the sealing profile 1, the fastening members 8a, 8b consequently overlap at least partially with the retention member 13.

As an alternative to the embodiment shown, the fastening portion can also have, for example, more than two projecting fastening members, that is to say, in particular, three or four fastening members. This makes it possible to brace the fastening portion with respect to a motor vehicle part, for example a vehicle door, in more than one spatial direction.

In an embodiment which is not shown, it is additionally possible to provide a covering cap which can be fitted at least partially onto the expansion element 10 and preferably also onto the fastening portion 7 and thus covers the expansion element 10 and, where applicable, also the fastening portion 7. In order to fix the covering cap, latching elements, e.g. laterally projecting ribs, can be provided on the fastening portion 7, in particular on one or more fastening members 8a, 8b. Correspondingly, corresponding latching elements can be arranged on the covering cap on an inner side facing the latching elements in order to hold the covering cap on the fastening portion 7 in a positive-locking manner.

Unless otherwise defined in the specific case, spatial designations such as “outside” and “inside” with regard to the motor vehicle and, in particular, the vehicle door should be understood with reference to the motor vehicle.

### LIST OF REFERENCE SIGNS

1 sealing profile
2 vehicle door
3a, 3b panels
4 window pane
5 sealing portion
6a, 6b sealing lip
7 fastening portion
8a, 8b fastening member
9 receptacle
10 expansion element
11 bearing surface
12 through hole
13 retention member
14 additional sealing lip
15 retention bracket
16 end face
17 retention ribs

1-16. (canceled)

17. A sealing profile for a motor vehicle, comprising: a sealing portion; and a fastening portion, wherein the fastening portion has at least two projecting fastening members, between which a receptacle for an expansion element is arranged.

18. The sealing profile according to claim 17, wherein the fastening members have a free end and a reducing cross section in one region in a direction away from the free end.

19. The sealing profile according to claim 18, wherein the region with the reducing cross section is formed at a transition of the fastening members to a bearing surface of the fastening portion.

20. The sealing profile according to claim 17, wherein the receptacle for the expansion element has a cross section that widens toward an open end of the receptacle.

21. The sealing profile according to claim 19, wherein the fastening members and/or the bearing surface are/is molded onto the sealing portion.

22. The sealing profile according to claim 17, wherein the sealing portion is an extruded sealing profile and the fastening portion is arranged in a free space, formed by stamping, of the sealing portion.

23. The sealing profile according to claim 17, wherein the sealing portion has a retention member for insertion into a window channel and/or a sealing lip for bearing against a window pane.

24. The sealing profile according to claim 23, wherein the retention member projects in a common direction with the fastening members.

25. The sealing profile according to claim 17, wherein the fastening portion is part of a molded edge that is molded onto the sealing portion or is overmolded as an insert by a molding.

26. The sealing profile according to claim 25, wherein the molded edge is made of polypropylene.

27. The sealing arrangement according to claim 25, wherein the molding is made of TPE or EPDM.

28. A sealing arrangement comprising: a sealing profile according to claim 17; a motor vehicle part that has a through hole through which the fastening members of the sealing profile project; and an expansion element arranged between the fastening members to push the fastening members apart so as to fix the sealing profile on the motor vehicle part.

29. The sealing arrangement according to claim 28, wherein the motor vehicle part is a vehicle door that has a slot formed as a window channel, into which the sealing portion of the sealing profile projects at least partially.

30. The sealing arrangement according to claim 29, wherein the through hole is arranged in a longitudinal direction of the window channel in the motor vehicle part.

31. The sealing arrangement according to claim 28, wherein the expansion element has a decreasing cross section in a longitudinal direction toward a free end.

32. The sealing arrangement according to claim 28, further comprising a covering cap connected to the fastening portion in a positive and/or nonpositive manner.

33. A method for fastening a sealing profile on a motor vehicle part, comprising the steps of:
inserting two fastening members of a fastening portion of the sealing profile into a through hole in the motor vehicle part in a first direction; and
inserting an expansion element into a receptacle between the fastening members in a direction opposite to the first direction to fix the sealing profile on the motor vehicle part.

34. The method according to claim 33, wherein the motor vehicle part is a vehicle door.

35. The method according to claim 34, further including inserting a retention member of a sealing portion of the sealing profile into a window channel of the vehicle door simultaneously with the inserting of the fastening members into the through hole.
